(19) United States
(12) Patent Application Publication
(10) Pub. No.: US 2013/0054050 A1
(43) Pub. Date: Feb. 28, 2013

(54) METHODS AND APPARATUS FOR A VEHICLE TO CLOUD TO VEHICLE CONTROL SYSTEM

(71) Applicants: Dimitar Petrov Filev, Novi, MI (US); Davorin David Hrovat, Ann Arbor, MI (US)

(72) Inventors: Dimitar Petrov Filev, Novi, MI (US); Davorin David Hrovat, Ann Arbor, MI (US)

(21) Appl. No.: 13/216,748

(22) Filed: Aug. 24, 2011

(51) Int. Cl. G06F 7/00

(52) U.S. Cl. 701/2

(57) ABSTRACT

A computer implemented method for efficiently operating a vehicle includes sending vehicle configuration data and route related data to a remote system. The method further includes receiving an optimization strategy, based at least in part on the vehicle configuration data and route related data, for optimizing at least one vehicle adjustable system for an upcoming road segment. Also, the method includes controlling the at least one vehicle adjustable system based on the optimization strategy over the upcoming road segment.

### TECHNICAL FIELD

The illustrative embodiments generally relate to methods and apparatus for a vehicle to cloud to vehicle control system.

### BACKGROUND

The emerging vehicular communication system—vehicle to vehicle (V2V) and vehicle to infrastructure (V2I)—is a network in which vehicles and roadside units are the communicating nodes exchanging information, such as safety warnings and traffic information. One main goal of the vehicular communication system is to support active safety vehicle features in avoiding accidents and traffic congestions by taking advantage of the information exchange with the surrounding vehicle and road infrastructure stations.

This communication system may be a communication with short range of 1000 m and works in 5.9 GHz band with bandwidth of 75 MHz. This communication system has been developed to primarily address the tasks related to accident avoidance. It has some potential for improving fuel economy, e.g. advising driver for smoother driving due to anticipated traffic movement, avoiding traffic congestions, selecting the optimal section of the route, etc. Its potential for impacting other vehicle attributes (fuel economy, drivability, comfort, reliability) is rather limited for two main reasons—the number of parameters exchanged between the vehicles and the short time horizon defining the validity of the data (determined by the 1000 m range).

Since vehicle computing systems have relatively low processing power compared to supercomputing resources available on remote servers, implementation of advanced data processing and fine-tuning refinement of vehicle systems may be difficult “on-site” (e.g., in the vehicle). Even though a large amount of on-line data relating to the refinement of system control may be available, transferring, accessing and processing this data in a real-time environment such that it is of use to the driver may be difficult using current vehicle computing systems as the central processing power.

### SUMMARY

In a first illustrative embodiment, a computer implemented method for efficiently operating a vehicle includes sending vehicle configuration data and route related data to a remote system. The method further includes receiving an optimization strategy, based at least in part on the vehicle configuration data and route related data, for optimizing at least one vehicle adjustable system for an upcoming road segment. Also, the method includes controlling the at least one vehicle adjustable system based on the optimization strategy over the upcoming road segment.

In a second illustrative embodiment, a computer implemented method for optimizing vehicle travel includes receiving a vehicle profile including route related data and vehicle configuration data from a vehicle computing system. The method further includes assembling an optimization strategy for at least one vehicle adjustable system for an upcoming segment of road, the strategy based at least in part on the route related data and the vehicle configuration data. Also, the method includes delivering the optimization strategy to the vehicle for implementation.

In a third illustrative embodiment, a computer implemented method for delivering optimization instructions includes sending vehicle configuration data and route related data to a remote system. The method also includes receiving an optimization strategy for optimizing at least one vehicle adjustable system for an upcoming road segment. The method further includes generating vehicle system level commands operable to adjust the at least one vehicle adjustable system, based at least in part on the optimization strategy and changing real-time driving conditions applied to the optimization strategy.

In still another illustrative embodiment, a method for configuring a vehicle for efficient operation includes sending vehicle configuration and route of travel information to a remote facility. The method also includes receiving an optimization strategy from the remote facility for altering at least one vehicle adjustable system for an upcoming segment of road, the strategy based in part on data relating to the route of travel and the vehicle configuration.

In another illustrative embodiment, a method for remotely optimizing vehicle travel includes receiving vehicle configuration and route of travel from a traveling vehicle. The method also includes delivering an optimization strategy to the vehicle for at least one of a plurality of vehicle adjustable systems for an upcoming segment of road, the strategy based in part on data relating to the route of travel and the vehicle configuration.

In a further illustrative embodiment, a method for efficiently operating a vehicle includes altering at least one vehicle adjustable system according to an optimization strategy received from a remote facility for an upcoming segment of road, the strategy based in part upon data relating to a route of travel and a vehicle configuration.

### BRIEF DESCRIPTION OF THE DRAWINGS

FIG. 1 shows an illustrative example of a vehicle computing system;

FIG. 2A shows an illustrative example of a cloud based process for suspension control;

FIG. 2B shows an illustrative example of a vehicle based process for suspension control;

FIG. 3A shows an illustrative example of a vehicle based process for accident avoidance;

FIG. 3B shows an illustrative example of a cloud based process for accident avoidance;

FIG. 4A shows an illustrative example of a vehicle based process for driver monitoring;

FIG. 4B shows an illustrative example of a cloud based process for driver monitoring;

FIG. 5 shows an illustrative example of a process for road mapping; and

FIG. 6 shows an illustrative example of a process for speed mapping.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

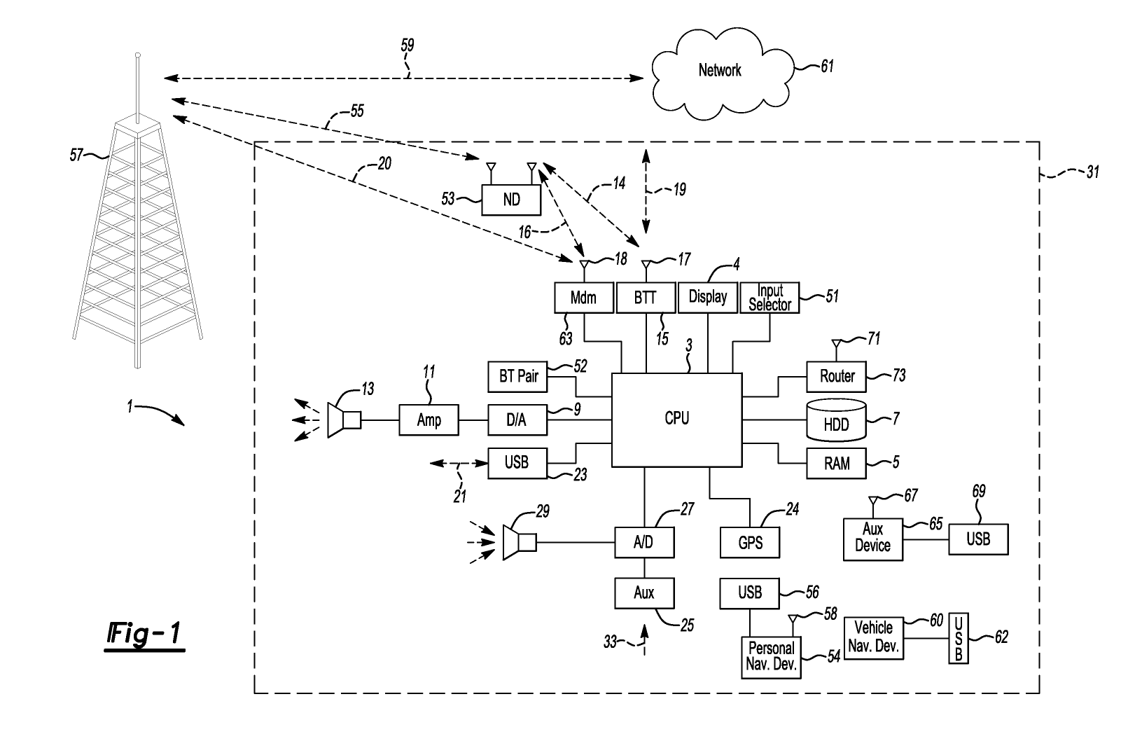

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen.

In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

The control system proposed as illustrative embodiments expands the concept of V2V and V2I communication to a different level—optimization of vehicle performance by taking advantage of two main sources of information—vehicle on-board control and use of web resources. Real-time optimization and machine learning are two of the main enabling technologies for improving vehicle performance (fuel economy, drivability, comfort). The broad application of these technologies, however, is rather unrealistic on the present on-board ECUs that are tasked to execute in the order of 100 distinct control and diagnostic functions. The implementation of even simple optimization algorithms is a formidable challenge due to limited computing capabilities of standard automotive ECUs.

An alternative approach is to perform optimization remotely while exchanging information with the vehicle on-board control system through wireless communications (using the phone modem). The idea of transferring some of the safety noncritical computational tasks to a remote server is a transformational extension of the current server based vehicle advisory systems that are used for concierge or infotainment purposes.

This concept is synergistic with the ideas of cloud computing, where servers with massive computing power are available on demand through internet requests. Unlike safety critical engine or transmission management functions, a fault tolerant implementation of higher level/supervisory tasks, such as route planning of a driving mode or of vehicle speed set-point, can be more easily achieved while relying on the cloud computing system for real-time optimization. Furthermore, intelligent agents, operating on remote servers that are dedicated to guiding vehicles in optimal ways (with respect to fuel economy, comfort, safety, etc.), can access a massive history of different vehicles driving the same route or same parts of the route accumulated over time over many different conditions.

Such an approach can take full advantage of the principles of cooperative learning to continuously update adequate vehicle and driver models that can support the optimization strategy. Consequently, the agents will be able to initialize the optimization algorithms with a good initial guess for optimal solution, thereby permitting fast convergence and enabling the use of optimization algorithms, such as iterative dynamic programming, sequential quadratic programming, and neighboring extremal optimal control that are particularly suitable to situations when a good initial guess is available.

This novel approach maximally utilizes the existing vehicle on-board control, information and communication systems and creates a novel software architecture that takes advantage of the cloud computing potential for establishing a collaborative environment for optimizing the fuel economy of the system including the specific vehicle, driver, road and traffic conditions.

The main idea is to expand the information channel that is presently used by a VCS for delivering infotainment services to the vehicle with the capability to periodically uploading specific vehicle data through an information portal to the web, and to expand the web with virtual web vehicle (VWV) pages corresponding to all subscribing vehicles.

Each virtual web vehicle (VWV) page may play the role of a virtual vehicle, containing essential static and dynamic information about the vehicle and supervisory commands for updating the low level control loops. The static information may consists of the main characteristics of the specific vehicle model, e.g. total mass, sprung and unsprung mass, front & rear wheel base, tire characteristics, shock absorber characteristics, engine calibration parameters (e.g., brake torque at different loads and engine speeds), etc.

The dynamic portion of the information may include time stamp, sampled GPS coordinates, data characterizing longitudinal, lateral, vertical, and rotational dynamics, fuel consumption, driver style and intentions, etc.

The command section includes recommended time stamped supervisory control set-points for the low level vehicle control systems, e.g. optimal ACC set-point, maximal speed for the specific road section and road conditions, optimal suspension damping & stiffness, etc.

While static data is uploaded once during the webpage setup, the dynamic data is uploaded on event basis, when a specific variable deviates from its running mean value. Command set-points are downloaded per the time stamps associated with them.

Command set-points are dynamically updated by software applications (agents) that implement specific algorithms operating with the data contained in the VWV pages and in the additional web information resources.

The VWV pages along with other web information resources, e.g. Electronic Horizon data base, create a virtual transportation web.

The concept of VWV allows for integration of the vehicle subsystems, external road, and traffic information. This wealth of information and the unlimited computational power and resources of the cloud provides opportunities for introducing powerful model based control algorithms combining models of motion dynamics, and system states of engine, transmission, wheel spin and wheel-hop—something that is impossible at a vehicle control level. It enables creation of autonomous supervisory algorithms (intelligent agents) that can take advantage of the integrated information and provide appropriate adjustment of the set-points of the low level vehicle control systems.

At least two groups of autonomous cloud based intelligent agents are contemplated—Performance Optimization Intelligent Agents and Service Intelligent Agents.

The first group consists of at least four main types of autonomous cloud based supervisory control algorithms (Performance Optimization Intelligent Agents) that operate autonomously with the information available on the web servers—Virtual Web Vehicle (VWV) pages, Electronic Horizon, Road Condition data base, and other web resources—and continuously update the Supervisory Command Sections of the VWVs that are further communicated to the vehicle control systems. The main types of performance optimization agents include (but are not limited to) Fuel Economy Optimization Agent, Ride Comfort/Handling/Active Safety Optimization Agent, Post Impact Path Optimization Agent, and Driver Health Monitoring Agent.

Fuel Economy Optimization Agents have been discussed in some detail in U.S. patent application Ser. No. 13/103,539 filed on May 9, 2011, entitled Methods and Apparatus for Dynamic Powertrain Management, the contents of which are incorporated herein by reference.

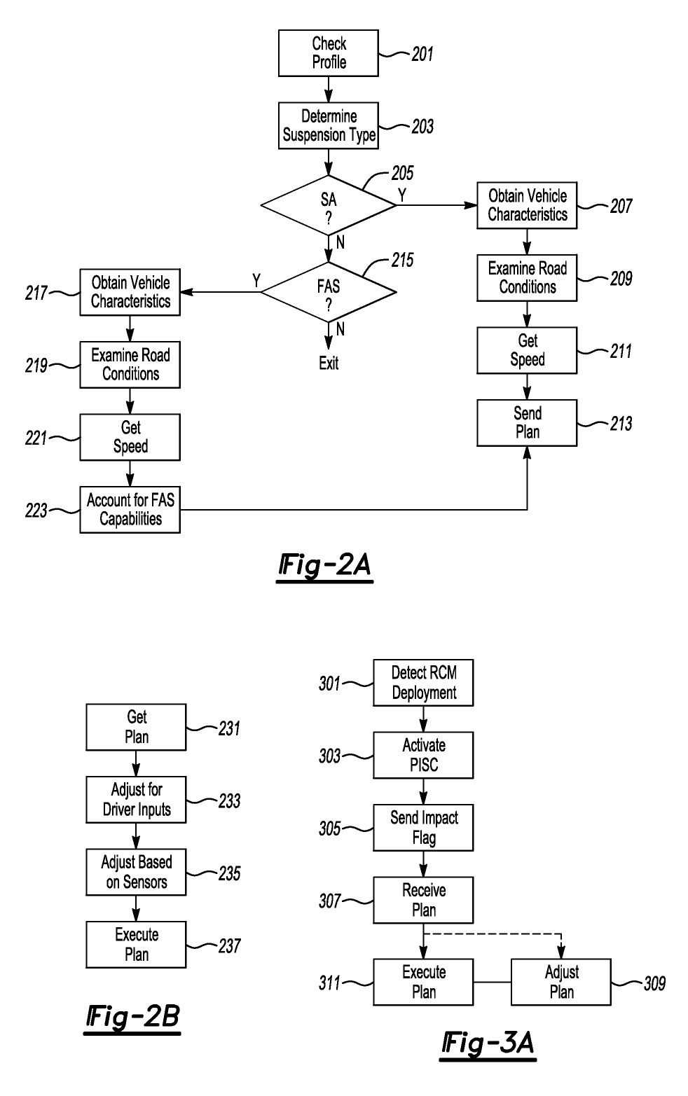

An example of a Ride Comfort/Handling/Active Safety Optimization Agent is shown with respect to FIGS. 2A and 2B. FIG. 2A shows an illustrative example of cloud based process for suspension control and FIG. 2B shows an illustrative example of a vehicle based process for suspension control.

For vehicles with semiactive suspensions (SA), one general process may be to calculate the optimal damping profile based on the vehicle static and dynamic characteristics, preview of Road Conditions database, and vehicle speed.

For vehicles with fully active suspensions (FAS), one general process may be to calculate the optimal FAS actuator force or height/displacement profile based on the vehicle characteristics, preview of Road Conditions database, and vehicle speed, taking into account many desired new/exciting functional capabilities facilitated by the FAS actuators.

There is typically a fine balancing act between ride & handling. For example, on the long, straight stretches of the road we may want to maximize the ride comfort. In this case the FAS setting would be more on a “soft” size like riding on a “magic carpet”. However, if there is a sudden obstacle on the road (e.g. an animal crossing the road) then the suspension has to be quickly “stiffened” to facilitate accident avoidance. Also, if there is a major pothole on the road (which can be identified via the Road Surface Mapping Agent discussed herein, for example) one could then appropriately reconfigure the FAS to avoid damaging impact with the pothole.

Once a vehicle has been engaged and is being driven on the road, a vehicle computing system may notify a cloud-based service that the journey is underway. The cloud based process will then check a static vehicle profile 201 to determine, for example, the type of suspension with which the vehicle is outfitted 203.

If the suspension is a semiactive (SA) suspension 205, the process may have one or more optimization algorithms associated with SA suspensions that it will apply to optimize travel. Inputs to these algorithms include, but are not limited to, other vehicle characteristics 207 (available from, for example, an online vehicle profile), road conditions (available from online resources including, but not limited to, the speed mapping and road condition mapping discussed herein), a vehicle speed and likely upcoming speed 211, etc.

This data can then be processed appropriately and a suspension control plan can be developed by the powerful cloud computing source 213. Since the cloud computing source can presumably access resources faster than and process information faster than the local vehicle computing system, it may be easier to actually handle and process data in a useful real-time manner using this model.

Alternatively, in this example, the suspension may be a fully active suspension (FAS) 215. Since this suspension has different settings available thereto than an SA suspension, it may be desirable to use a different set of algorithms to handle data processing. Again, vehicle characteristics 217, road conditions 219 and a vehicle speed and projected speed 221 can be used. Then, in this example, additional accounting may be made for FAS capabilities that an SA suspension may not have 223. Again, a suspension management plan is delivered to the vehicle computing system.

In FIG. 2B, the vehicle computing system receives the high-level plan from the cloud 231. A module within the VCS may then translate the plan into commands for the suspension control, and may even make minor adjustments to the plan based on observed real time changes. These can include, but are not limited to, changes in Driver input 233 (speed changes, course changes, etc.) or changes observed in vehicle sensors 235 (e.g., road conditions that do not match projected modeling). The plan is then executed by the VCS 237, as appropriate commands are delivered to the suspension control module(s).

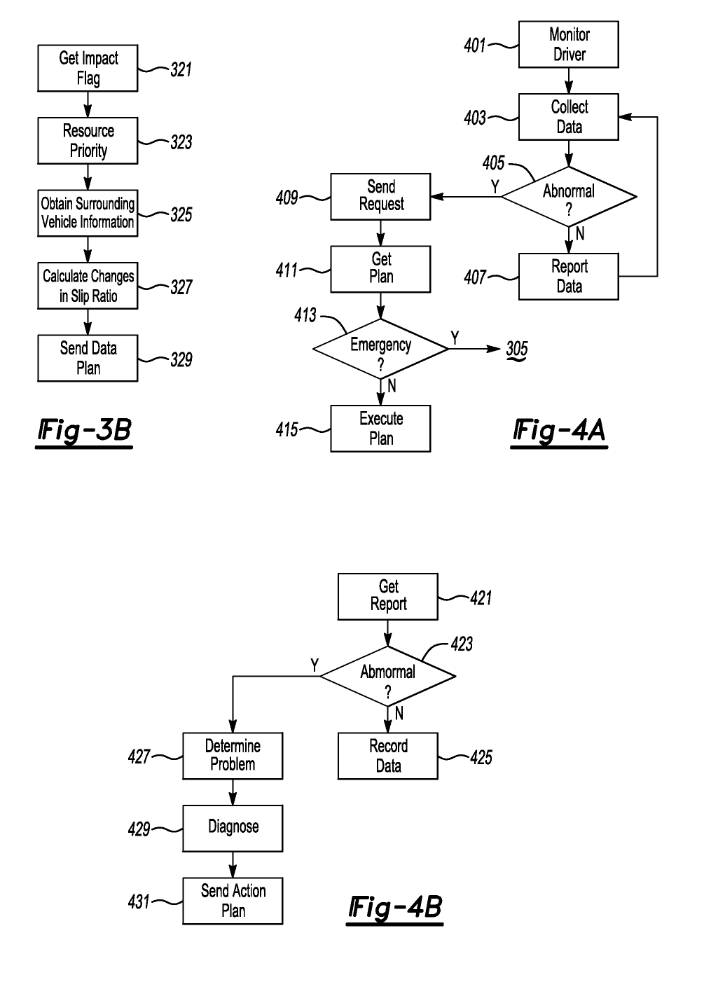

FIG. 3A shows an illustrative example of a vehicle based process for accident avoidance and FIG. 3B shows an illustrative example of a cloud based process for accident avoidance.

In more general terms, when considering the Active Safety and accident avoidance maneuvers, presence of the clouds can be used to perform “high-level” optimization and embedded control SW can then be used to perform further on-the-spot tuning and refinements depending on changing ground/environment conditions. Considering the present—and even more so future—resolution capabilities of web based map-type of pictures and assuming future high rates of picture taking capabilities, one can imagine a scenario where via a cloud we will be able to have a full “birds view” of an potential accident scene with all relevant vehicles and other objects (animated or not) been taken into account.

It will then be possible to obtain an optimized scenario of vehicle motions (taking into account vehicle characteristics, for example, and all the environmental constraints available) using high-computational power associated with the cloud. The so derived vehicle trajectory will then be transmitted to the vehicle as the desired trajectory to be used for on-board optimization (using MPC, for example) taking into account driver inputs, vehicle dynamics and different constraints the id of which can be further refined by on board cameras, LIDARs and other sensors for a near-3D recognition (as opposed to “birds-view” used at cloud level optimization, which however has to deal with the whole scenery taking into account all relevant moving and non-moving objects).

It is conceivable that the combined cloud—vehicle calculation/optimization will be done at different, i.e. “hybrid” rates, where typical cloud calculations will be at slower update rates than the ones for on-board vehicle cases. In addition, on-board calculation would be used as a default process when cloud data are not available (due to cloudy skies and other reasons).

A current Post Impact Stability Control (PISC) system may be activated by the restrain control module (RCM) and applies brakes to quickly stop the vehicle ignoring the steering control commands that might be result of the actions of a panicked driver. A Post Impact Path Optimization agent could expand this functionality.

The agent may be activated in simultaneously with the activation of the PISC by sending an immediate impact flag through the web interface when the RCM is deployed. The agent uses the information about the positions of the surrounding vehicles at the crash scene (these positions are available from the GPS coordinates of the vehicles in close radius around the crashed vehicle), calculates and sends the desired changes in slip ratios to the low level controller.

This is information allows the PISC system to not only brake the crashed vehicle but to also avoid collisions with other vehicles. Implementation of a similar functionality on board is not feasible since at the moment of crash the crashed vehicle cannot immediately recreate the scene due to the loss of orientation. The Post Impact Path Optimization Agent uses the information from the last snapshot before the crash to navigate the crashed vehicle following a path that would minimize the chances for collision with other vehicles.

In FIG. 3A, the VCS module or system detects activation of the RCM 301. As a result of this detection, the PISC system is engaged 303 and an impact flag notification is sent to the cloud 305.

The cloud receives the impact flag 321 and may, in this example, request for resource prioritization 323. Since the impact flag is indicative of a likely accident, to the extent that resources are at a premium or available on a limited basis, the resources may be given to accident control processes in a prioritized manner. This should help allocate resources to accident avoidance in an efficient manner.

Information relating to surrounding vehicles, obtained, for example, from the last snapshot before the crash, may be used by the online process 325. The process may then calculate the desired changes in slip ratios to the low level controller 327. These changes can be delivered to the VCS 329.

Upon receipt of the plan from the remote server (or upon receipt of direct PISC module control commands) 307, the VCS may apply any necessary corrections 309 and/or implement the plan 311.

FIG. 4A shows an illustrative example of a vehicle based process for driver monitoring and FIG. 4B shows an illustrative example of a cloud based process for driver monitoring.

This agent continuously collects and summarizes long-term information about a state of the driver and driving style that is preprocessed on-board. Additional information about the physiological state of the driver provided by medical on-board devices is also collected.

The long-term information is use to establish a “normality” pattern of the specific driver. The agent implements anomaly detection algorithms to evaluate the probability of deviation from the multidimensional normal state and identify abnormal situation. In this case the Driver Health Monitoring Agent submits a recommended set of default actions that can safely stop the vehicle and avoid collisions and traffic accidents. If the recommended actions are ignored the Driver Health Monitoring Agent implements a set of commands that are provided by the algorithm of the Post Impact Path Optimization Agent in order to guarantee a safe stop and to avoid traffic accidents.

Generally, the VCS based portion of this agent is monitoring any medical devices 401 and/or other systems in the vehicle that can provide a baseline for a driver state and driving style. This data can be stored locally 403 and uploaded periodically for analysis 407, unless an abnormality occurs 405.

Initially, abnormalities can be observed based on some generalizations about people of the driver's age and physical condition, but over time the baseline can be fine-tuned to correspond to a specific driver. If a deviance from an acceptable norm is detected, a request for advice from a remote source can be sent 409.

When the cloud receives the request, it may also include the data that the system determined as being abnormal 421. If the abnormality is verified 423, then a diagnostic approach can be taken. The system can, using known medical information and cloud based resources, determine the potential problem 427 and diagnose the driver's condition 429. Based on the severity of the condition, an action plan can be devised and sent to the vehicle for implementation 431.

If the cloud based system disagrees that an emergency action needs to be taken, the data can be recorded 425 as if it were a normal report. Other steps, like temporarily increased reporting, can be taken in an instance like this to ensure that a questionable condition does not evolve into a dangerous one.

The VCS receives the plan from the remote source 411 and determines if an Emergency condition is present 413. This determination could be made, for example, based on the serverity of the detected deviance, or based on the driver ignoring recommended actions provided in conjunction with the returned plan (e.g., the driver may have lapsed in semi- or unconsciousness).

If there is an Emergency state, the process may engage PISC accident avoidance control 303, which may safely get the vehicle to the side of the road. Otherwise, the process may execute the plan 405, which may be as simple as delivering a set of recommendations to a driver, but which may also include engaging certain safety controls and/or dialing an emergency operator.

Other agent types may include Service Intelligent Agents. These are agents that collect and summarize the information from all vehicles and update generic web resources—traffic, road grade, road conditions, road surface, etc.

For those agents the vehicles functions as sensors and the role of the agents is to summarize, generalize, validate, and store the collected information for general use. These agents essentially update, maintain, and enrich the available web information that is used by the first group of agents—the Performance Optimization Agents.

The Service Intelligent Agents include but are not limited to Road Surface Mapping Agent, Road Grade Probabilistic Mapping Agent, and Traffic Speed Probabilistic Mapping Agent.

Presently, detailed road maps that provide updated information about the road surface are not available. Although a high definition road surface map can be obtained by using a laser scanner, the practical use of this approach is rather limited. However, the fact that multiple vehicles travel the same roads defines an opportunity for automatically mapping the road conditions using the suspension height sensor measurements for vehicles that are equipped with this type of sensors.

The task seems simple-suspension height measurements combined with the vehicle model (suspension linkage ratios and suspension geometry) can be used to reconstruct the road profile; the road profile along with the GPS coordinates can produce a map of the road. This is not practical since a task of this type would take all the available capacity of the communication channel.

The problem with data can be resolved by applying an anomaly detection procedure that would identify the running mean and normal variance of the road surface. Only values of road profile that are out of the normality band around the running mean, along with their GPS coordinates, would qualify for submission to the Road Mapping Agent.

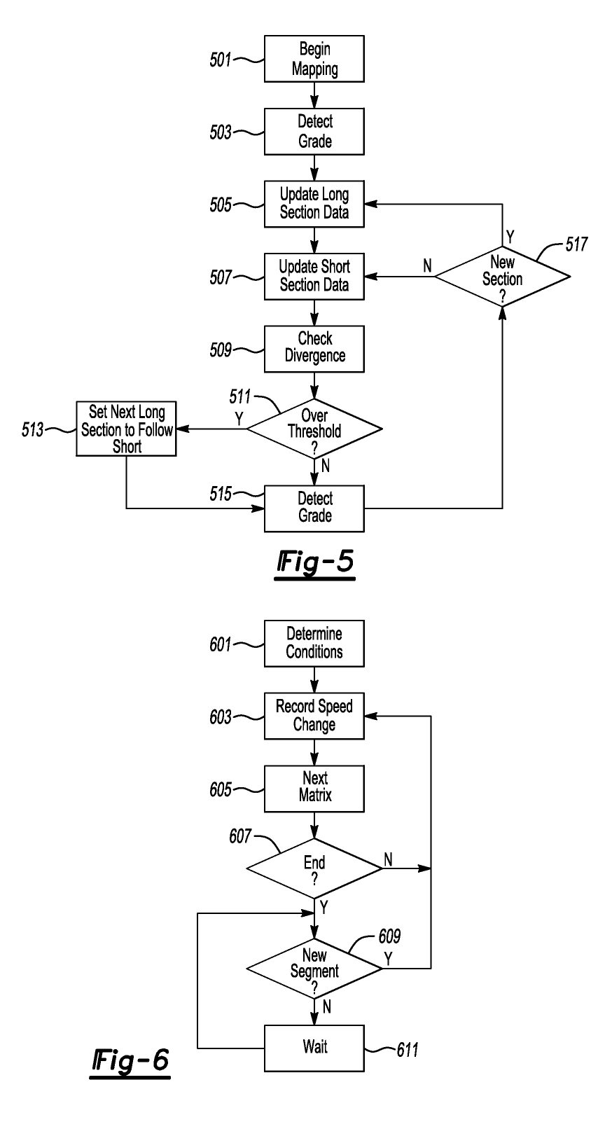

FIG. 5 shows an illustrative example of a process for road mapping. If the Electronic Horizon is not available, the prototypical road grade in a geographic area can be summarized by a probabilistic (Markov) model. The model defines the probability of changing the grade in the next segment S. For example, if the grade range [−6%, 6%] is discretized into 12 intervals 1ᵢ, i={1, 12} of 1%, the transition probability matrix of the Markov model defines the probabilities that in the next S=30 m segment 517 the grade can change from −6 to −5, −4, −3, . . . [%].

A model of that type can be used to approximate the type of roads in a specific geographic area. The Road Grade Mapping Agent implements the algorithm for real time learning the frequencies of transitions between the grade intervals 1ᵢ, i={1, 12}.

Once a vehicle is traveling on a road to be mapped, the mapping process can begin 501.

In order to approximate the entire road with probabilistic models of the grade, an Evolving Probabilistic Road Grade Mapping algorithm that uses the concept of evolving probabilistic (Markov) models. The model uses the Kullback-Leibeler (KL) divergence measure to identify dissimilarity in the transition probability models that approximate the road grade for different road segments.

Let Pᵢ^{(s)} and Pᵢ^{(f)} be the Markov models of the transition probabilities of the grade change along the i-the section of the road. Both models are defined on the same set of states; the only difference between them is in the rate of updating the transition probabilities. The model Pᵢ^{(s)} is updated very slowly 505 and represents a summary of the road grade distribution 503 for a long section of the road, while the probabilities in the model Pᵢ^{(f)} are updated with a faster rate 507 and reflect the section of the road 503, 515 where the vehicle travels at the moment.

The KL divergence 509 measure between the models Pᵢ^{(s)} and Pᵢ^{(f)} indicates the similarity between the two models. Small value of the KL measure determines that the road grade distribution remains unchanged 511 as the vehicle travels along the road and vice versa, an increasing value of KL divergence 511 points out for a significant change in the terrain.

Therefore, a significant increase of the KL divergence would indicate that the model Pᵢ^{(s)} approximating the i-th section of the road is no longer valid and the next section should be associated with the current model Pᵢ^{(f)}, i.e. the model summarizing the grade distribution for the next (i+1)-th section is Pᵢ₊₁^{(s)}:=Pᵢ^{(f)} 513.

This way road sections of different length but stationary transition probability matrices are identified in a manner similar to the k-NN Neighbor clustering method. The segments and the associated Markov models are not fixed but evolve based on the KL diversion quantified similarity/dissimilarity of the identified transition probability matrices.

The prototypical traffic speed for a road under different conditions—time of the day, day of the week—can be mapped similarly by superimposing the outputs of corresponding probabilistic (Markov) models. Each of the models defines the probability of changing the vehicle speed in the next segment S. For example, if the speed range [0, 70 mph] is discretized into 10 intervals 1ᵢ, i={1, 10} of 7 mph, a single transition probability matrix P, applies to a specific set of conditions (e.g. late AM, week day) and defines the probabilities that in the next S=30 m segment the average speed can change from 0 to 7, 14, . . . mph].

The Traffic Speed Mapping Agent implements the algorithm for real time learning the frequencies of transitions between the speed intervals 1ᵢ, i={1, 12} under possibilistic Conditions 1 & 2 by weighted superposition.

FIG. 6 shows an illustrative example of a process for speed mapping.

In this illustrative example, a plurality of conditions for which individual matrices are to be formed are determined 601. For each segment, under each matrix, a speed change is recorded based on observed conditions 603. This process is repeated for all varying condition matrices 605, 607. Once this data has been observed and sufficient data sets are available, the prototypical traffic speed for a road under different conditions—time of the day, day of the week—can be mapped similarly by superimposing the outputs of the corresponding probabilistic (Markov) models.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer implemented method for efficiently operating a vehicle comprising:
sending vehicle configuration data and route related data to a remote system;
receiving an optimization strategy, based at least in part on the vehicle configuration data and route related data, for optimizing at least one vehicle adjustable system for an upcoming road segment; and
controlling the at least one vehicle adjustable system based on the optimization strategy over the upcoming road segment.

2. The method of claim 1, wherein the at least one vehicle adjustable system includes a suspension system.

3. The method of claim 1, wherein the at least one vehicle adjustable system includes a post-impact stability control system

4. A computer implemented method for optimizing vehicle travel comprising:
receiving a vehicle profile including route related data and vehicle configuration data from a vehicle computing system;
assembling an optimization strategy for at least one vehicle adjustable system for an upcoming segment of road, the strategy based at least in part on the route related data and the vehicle configuration data; and
delivering the optimization strategy to the vehicle for implementation.

5. The method of claim 4, wherein the vehicle configuration data includes total mass.

6. The method of claim 4, wherein the vehicle configuration data includes sprung and unsprung mass.

7. The method of claim 4, wherein the vehicle configuration data includes front and rear wheel base.

8. The method of claim 4, wherein the vehicle configuration data includes tire characteristics.

9. The method of claim 4, wherein the vehicle configuration data includes shock absorber characteristics.

10. The method of claim 4, wherein the vehicle configuration data includes engine calibration parameters.

11. The method of claim 4, wherein the route related data includes a time stamp.

12. The method of claim 4, wherein the route related data includes sampled GPS coordinates.

13. The method of claim 4, wherein the vehicle configuration data includes data characterizing longitudinal, lateral, vertical, and rotational dynamics.

14. The method of claim 4, wherein the vehicle configuration data includes fuel consumption.

15. The method of claim 4, wherein the vehicle configuration data includes driver style and intentions.

16. The method of claim 4, wherein the at least one vehicle adjustable system includes a suspension system.

17. The method of claim 4, wherein the at least one vehicle adjustable system includes a post-impact stability control system.

18. A computer implemented method for delivering optimization instructions comprising:
sending vehicle configuration data and route related data to a remote system;
receiving an optimization strategy for optimizing at least one vehicle adjustable system for an upcoming road segment; and
generating vehicle system level commands operable to adjust the at least one vehicle adjustable system, based at least in part on the optimization strategy and changing real-time driving conditions applied to the optimization strategy.

19. The method of claim 18, wherein the at least one vehicle adjustable system includes a suspension system.

20. The method of claim 18, wherein the at least one vehicle adjustable system includes a post-impact stability control system.

21. A method for configuring a vehicle for efficient operation comprising the steps of:
sending vehicle configuration and route of travel information to a remote facility; and
receiving an optimization strategy from the remote facility for altering at least one vehicle adjustable system for an upcoming segment of road, the strategy based in part on data relating to the route of travel and the vehicle configuration.

22. A method for remotely optimizing vehicle travel comprising the steps of:
receiving vehicle configuration and route of travel from a traveling vehicle; and
delivering an optimization strategy to the vehicle for at least one of a plurality of vehicle adjustable systems for an upcoming segment of road, the strategy based in part on data relating to the route of travel and the vehicle configuration.

23. A method for efficiently operating a vehicle comprising:
altering at least one vehicle adjustable system according to an optimization strategy received from a remote facility for an upcoming segment of road, the strategy based in part upon data relating to a route of travel and a vehicle configuration.
